(19) United States
(12) Patent Application Publication
(10) Pub. No.: US 2024/0391102 A1
(43) Pub. Date: Nov. 28, 2024

(54) METHOD FOR CONTROLLING A ROBOT DEVICE

(71) Applicant: Deutsches Zentrum für Luft- und Raumfahrt e.V., Bonn (DE)

(72) Inventors: Marco DE STEFANO, Oberpfaffenhofen-Weßling (DE); Christian OTT, Wien (AT); Ria VIJAYAN, Oberpfaffenhofen-Weßling (DE); Hrishik MISHRA, Oberpfaffenhofen-Weßling (DE); Ferdinand ELHARDT, Oberpfaffenhofen-Weßling (DE)

(73) Assignee: Deutsches Zentrum für Luft- und Raumfahrt e.V., Bonn (DE)

(21) Appl. No.: 18/675,669

(22) Filed: May 28, 2024

(30) Foreign Application Priority Data
May 25, 2023 (DE) 10 2023 113 815.4

(51) Int. Cl. B25J 9/16; B25J 9/12; B25J 17/00

(52) U.S. Cl. CPC B25J 9/1664; B25J 9/12; B25J 17/00

(57) ABSTRACT

A robot device that has a robot element pivotable about a first robot joint is controlled by a method including the steps of: moving the robot element by an actuator; controlling the actuator by an actuator control device that sends control signals to the actuator; and supporting the robot device by a support device. gravity-compensating control signals are sent to the support device by a support control device. The support device is controlled such that a force and/or a moment is applied to the robot element via a force-applying element connected to the robot element. The force and/or moment compensates for the gravitational load acting on the robot element. To compensate for the gravitational force acting on the robot element, gravity-compensating second control signals are sent from the support control device to the support device, and gravity-compensating control signals are also sent from the actuator control device to the actuator.

### CROSS-REFERENCE TO RELATED APPLICATIONS

This application claims priority under 35 U.S.C. § 119 to German patent application DE 10 2023 113 815.4, filed May 25, 2024, the entire disclosure of which is incorporated herein by reference.

### BACKGROUND OF THE DISCLOSURE

### 1. Field of the Disclosure

The disclosure relates to a method for controlling a robot device and to a robot system.

### 2. Description of Related Art

Robot devices which are manufactured in particular for use in space are known. Space robot devices are constructed for the conditions prevailing in space. Since no gravitational forces act on the space robot device in space, a large part of the forces necessary because of gravitation can be ignored when designing the space robot device. Thus, the joints and/or actuators can be dimensioned to be smaller, lighter and more energy efficient.

However, the robot devices are also to be operated on earth, for example, to test or improve the robot devices. The robot device must be supported for this purpose, as otherwise, the joints would be overloaded, or the actuators would not be able to move the robot device. Support facilities exist for this purpose, which support the robot devices on earth. This is achieved, for example, with helium balloons or by using planar, active, or passive support tables. Helium balloons, which can be several meters in diameter depending on the load capacity, help to relieve the load through their buoyancy. These are mounted at the designated points on the robot device and pull the robot device upwards at this point with a constant force. Planar mobile support tables can, for example, glide over smooth floors and support the joints of the robot device. With this method, however, the robot devices can only perform planar movements.

Since the robot device is designed for a gravity-free operating environment, it can easily happen that the torque limits of the joints of the robot device are reached in certain configurations. The working area for tests on the ground is, therefore, limited. There is an increasing need to find an optimal strategy for gravitational force compensation.

### SUMMARY OF THE DISCLOSURE

Therefore, it is an object of the present disclosure to provide a method for controlling a robot device and a robot system in which the strategy for gravitational force compensation is optimized.

The object is achieved with the features disclosed herein.

The disclosure advantageously provides that in order to compensate for the gravitational force acting on the robot element, not only gravity-compensating second control signals are sent from the support control device to the support device, but also additional first gravity-compensating control signals are sent from the actuator control device to the actuator which moves the at least one robot element.

The present disclosure has the advantage that the gravitational load acting on the robot element is compensated both by the support device and by a suitable control of the robot element itself. In this way, the joint moments of the robot element can be minimized in order to comply with its torque limits.

The gravitational load acting on the robot device can be calculated by a computer device and, depending thereon, the gravity-compensating first and second control signals can be calculated by the computer device and be sent to the actuator control device and the support control device.

The compensation of the gravitational load by means of the computer device can be divided into the gravity-compensating first control signals and the gravity- compensating second control signals, wherein the distribution between the first and second control signals can be determined as desired by means of the computer device.

The optimum distribution of the gravity-compensating first control signals and the gravity-compensating second control signals can be calculated using the computer device.

The distribution of the gravity-compensating first control signals and the gravity-compensating second control signals can be optimized by means of the computer device such that the required torque or torques in the at least one robot joint are reduced.

The at least one actuator can be a motor at or in the at least one robot joint.

The gravity-compensating second control signal can be calculated by the computer device as follows:

$${γ}_{c}^{*} = {( {W}_{γ} + {J}_{cA} {W}_{τ} {J}_{cA}^{T} )}^{- 1} {J}_{cA} {W}_{τ} {G}_{A} .$$

γY*_{c} is a vector including forces and moments. The matrices W_{τ} and W_{γ} are the positive weighting matrices not equal to zero for the joint moments of the robot device and the forces of the support device. They can be used to define the distribution of the gravitational load between the robot device and support device. G_{A} is a selection of the gravitational loads that are subtracted from the previously calculated total gravitational load G.

The Jacobian matrix J_{cA} is necessary to transform the forces between the frames. The equation J_{cA}^{T}=J_{A}^{T}B^{T} is also used to define which components are to be taken into account. B contains information on which components the support device can implement. For example, the support device can only apply forces and therefore B=(I, 0), where I is a 3-dimensional identity matrix corresponding to the 3 force components.

The additional gravity-compensating first control signals can be calculated by the computer device as follows:

$${τ}_{gA}^{*} = ( I - {{J}_{cA}^{T} ( {W}_{γ} + {J}_{cA} {W}_{τ} {J}_{cA}^{T} )}^{- 1} {J}_{cA} {W}_{τ} ) {G}_{A}$$

τ*_{gA} is an additional torque component for the robot device. The matrices W_{τ} and W_{γ} are the positive weighting matrices not equal to zero for the joint moments of the robot device and the forces of the support device. They can be used to define the distribution of the gravitational load between the robot device and support device. G_{A} is a selection of the gravitational loads that are subtracted from the previously calculated total gravitational load G.

The Jacobian matrix J_{cA} is necessary to transform the forces between the frames. The equation J_{cA}^{T}=J_{A}^{T}B^{T} is also used to define which components are to be taken into account. B contains information on which components the support device can implement. For example, the support device can only apply forces and therefore B=(I, 0), where I is a 3-dimensional identity matrix corresponding to the 3 force components.

The actuator control device and the support control device can be a common control device.

The support device can be a parallel robot system or a serial kinematic system that comprises at least one actuator that can move the elements of the support device, so that the direction and magnitude of the force that can be exerted on the robot element can be adjustable.

The support device can be a cable robot system comprising at least two cable elements, each cable element being connected to at least one motor that can move the respective cable element so that the direction and amount of force that can be applied to the robot element can be adjusted.

The support device can also be an industrial robot.

According to the present disclosure, a robot system can be provided comprising:
a robot device, the robot device comprising at least one robot element pivotable about at least one first robot joint, comprising:
at least one actuator for moving the at least one robot element,
at least one actuator control device for controlling the actuator, the actuator control device being configured to send a first control signal to the actuator,
at least one support device for supporting the robot device, a support control device being provided which is configured to send second gravity-compensating control signals to the support device and thus to control the support device such that at least one force and/or a moment can be applied to the robot element via a force-applying element which is connected to the robot element at at least one point, which force and/or moment at least partially compensates for the acting gravitational load acting on the robot element,
in order to compensate for the gravitational force acting on the robot element, the support control device and the actuator control device are configured to not only send gravity-compensating second control signals from the support control device to the support device, but to also send additional first gravity-compensating control signals from the actuator control device to the actuator.

A computer device can be provided which is configured to calculate the gravitational load acting on the robot device and, depending on this, to calculate the gravity-compensating first and second control signals and send them to the actuator control device and the support control device.

The at least one actuator can be a motor at or in the at least one robot joint.

The computer device can be configured to divide the compensation of the gravitational load into the gravity-compensating first control signals and the gravity-compensating second control signals, wherein the distribution between the first and second control signals can be determined as desired by means of the computer device.

The computer device can be configured to calculate the optimum distribution of the gravity-compensating first control signals and the gravity-compensating second control signals.

The computer device can be configured to optimize the distribution of the gravity-compensating first control signals and the gravity-compensating second control signals such that the required torque or torques in the at least one robot joint are reduced.

### BRIEF DESCRIPTION OF THE DRAWINGS

In the following, embodiments of the present disclosure are described in more de-tail with reference to the figures.

FIG. 1 shows a robot system according to the present disclosure.

FIG. 2 shows a robot system according to the present disclosure with an industrial robot.

FIG. 3 shows a robot system according to the present disclosure with a rope pull system.

FIG. 4 shows a schematic illustration of the method according to the present disclosure.

FIG. 5 shows a further robot system according to the present disclosure.

FIGS. 6 to 8 show the results of tests with the robot system of the present disclosure.

FIG. 9 shows a further robot system according to the present disclosure.

FIGS. 10 to 13 show further results of tests with a robot system of the present disclosure.

### DETAILED DESCRIPTION OF THE DISCLOSURE

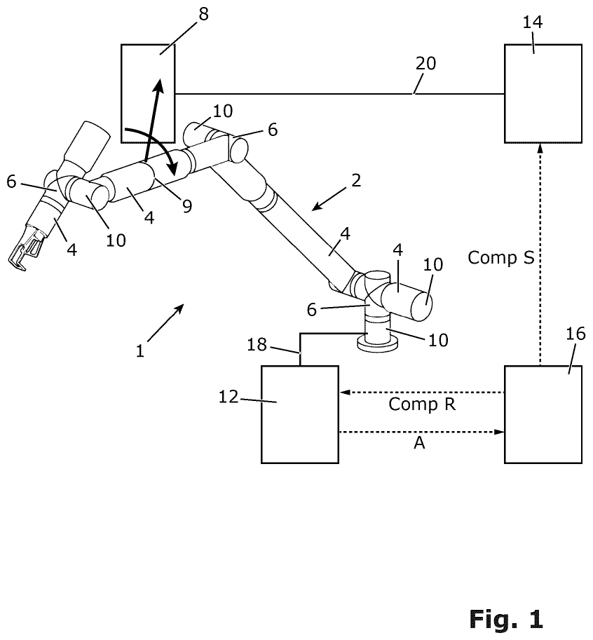

FIG. 1 illustrates a robot system 1 according to the present disclosure. A robot device 2 is shown, which comprises at least one robot element 4 that can be pivoted about at least one robot joint 6. In the embodiment shown, the robot device comprises several robot elements 4, each of which can be pivoted about robot joints 6. Operation takes place under the influence of gravity, e.g. on the surface of the earth.

The robot elements can each be moved by means of at least one actuator 10. As shown in the embodiment illustrated, the actuators can be motors arranged in or at the robot joints 6. The actuators 10 of the robot device can be controlled by means of an actuator control device 12, with first control signals 18 being sent to the at least one actuator 10.

Moreover, a support device 8 is provided. Using a support control device 14, second gravity-compensation control signals 20 can be sent to the support device 8 and the support device 8 can be controlled thereby such that at least one force and/or a moment can be applied to the robot element via a force-applying element 9 which is connected to at least one robot element 1 at at least one point, which force and/or moment at least partially compensates for the acting gravitational load acting on the robot element 4 or the robot device 2.

In order to compensate for the gravitational force acting on the at least one robot element 4, it is possible to not only send gravity-compensating second control signals 20 from the support control device 14 to the support device 8, but also to send additional first gravity-compensating control signals 18 from the actuator control device 12 to the actuator 10.

The gravitational load acting on the robot device 1 can be calculated by a computer device 16 and, depending thereon, the gravity-compensating first and second control signals 18, 20 can be calculated by the computer device 16 and be sent to the actuator control device 12 and the support control device 14.

The actuator control device 12 of the robot device 1 provides the control signals for the actuators of the robot device 1 and can also react to signals from sensors.

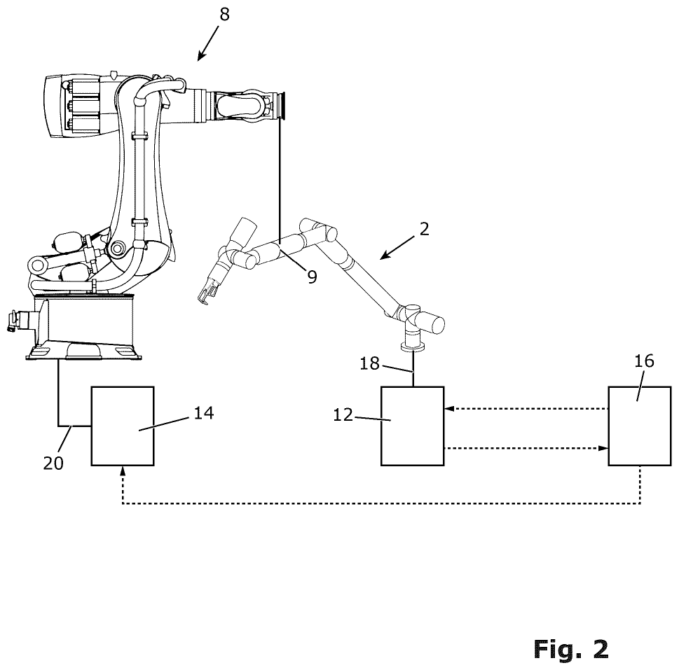

As shown in FIG. 2, the support device 8 can be an industrial robot arm, which can apply a force and/or a torque to the robot device 1 via a force application element 9.

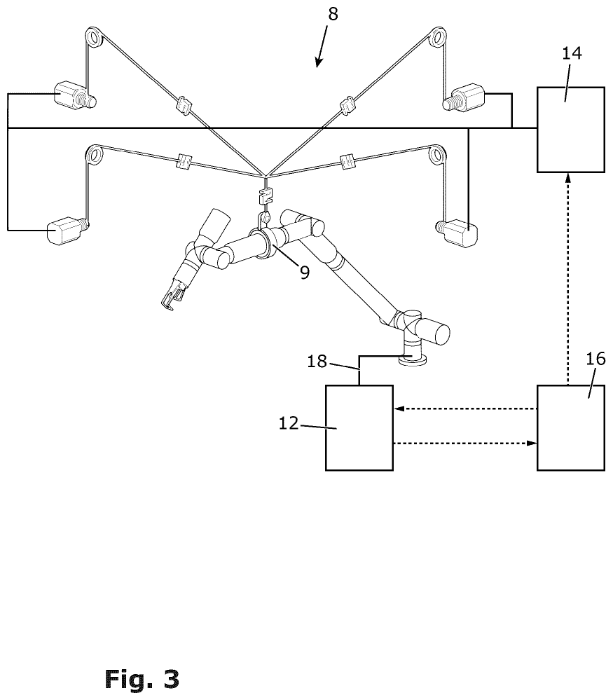

As an alternative, the support device 8 can also be a cable robot system, as illustrated in FIG. 3, comprising at least two cable elements, each cable element being connected to at least one motor that can move the respective cable element so that the direction and amount of force that can be applied to the robot element can be adjusted.

The support device 8 is mechanically coupled to the robot device 1 via the force application element 9. Forces and/or moments can be transmitted to the robot device 1.

The gravitational load acting on the robot device 1 can be calculated by a computer device 16 and, depending thereon, the gravity-compensating first and second control signals can also be calculated by the computer device 16 and be sent to the actuator control device 18 and the support control device 14.

The compensation of the gravitational load by means of the computer device 16 can be divided into the gravity-compensating first control signals and the gravity-compensating second control signals 18, 20, wherein the distribution between the first and second control signals 18, 20 can be determined as desired by means of the computer device 16.

In the illustrated embodiment, the computer device 16, the actuator control device 18 and the support control device 14 are shown separately from one another. However, the computer device 16 and/or the actuator control device 18 and/or the support control device 14 can also be a common control device.

The optimum distribution of the gravity-compensating first control signals 18 and the gravity-compensating second control signals 20 can be calculated using the computer device 16.

The distribution of the gravity-compensating first control signals 18 and the gravity-compensating second control signals 20 can be optimized by means of the computer device 16 such that the required torque or torques in the at least one robot joint 6 are reduced.

The computer device 16 can use information from the robot system 1, in particular the positions of the robot joints 6. This information can be transmitted via the signal line A. From tis, the computer device 16 calculates the gravitational forces acting on the robot system 1 or the robot device 2 or the robot elements 4. These gravitational forces are to be compensated by means of additional first control signals to the robot device 2, as well as second control signals to the support device 8. The control signals 18 for the robot device 2 are transmitted via the signal line (Comp_R), the control signal for the support device 8 being transmitted via the signal line (Comp_S).

The method according to the present disclosure preferably uses the computer device 16 to calculate gravity-compensating control signals. The objective of the calculation is a reduction of the necessary torques in the robot joints 6 of the robot device 2. It is another objective to obtain an adjustable distribution of the gravitational load between the robot device 2 and the support device 8.

First, the computer device 16 can calculate the gravitational force G required for the robot device 2. For this purpose, the computer device 16 requires information about the position of the robot joints 6 from the robot device 2.

Then the gravity-compensating second control signal can be calculated by the computer device 16 as follows:

$${γ}_{c}^{*} = {( {W}_{γ} + {J}_{cA} {W}_{τ} {J}_{cA}^{T} )}^{- 1} {J}_{cA} {W}_{τ} {G}_{A} .$$

γ*_{c} is a vector containing forces and torques. γ*_{c} can also be referred to as a wrench for the support device 8. The matrices W_{τ} and W_{γ} are the positive weighting matrices not equal to zero for the joint moments of the robot device and the forces of the support device. They can be used to define the distribution of the gravitational load between the robot device and support device. G_{A} is a selection of the gravitational loads that are subtracted from the previously calculated total gravitational load G.

The Jacobian matrix J_{cA} is necessary to transform the forces between the frames. The equation J_{cA}^{T}=J_{A}^{T}B^{T} is also used to define which components are to be taken into account. B contains information on which components the support device can implement. For example, the support device can only apply forces and therefore B=(I, 0), where I is a 3-dimensional identity matrix corresponding to the 3 force components.

The additional gravity-compensating first control signals can be calculated by the computer device 16 as follows:

$${τ}_{gA}^{*} = ( I - {{J}_{cA}^{T} ( {W}_{γ} + {J}_{cA} {W}_{τ} {J}_{cA}^{T} )}^{- 1} {J}_{cA} {W}_{τ} ) {G}_{A}$$

τ*_{gA} is an additional torque component for the robot device. The matrices W_{τ} and W_{γ} are the positive weighting matrices not equal to zero for the joint moments of the robot device and the forces of the support device. They can be used to define the G_{A} distribution of the gravitational load between the robot device and support device. G_{A} is a selection of the gravitational loads that are subtracted from the previously calculated total gravitational load G.

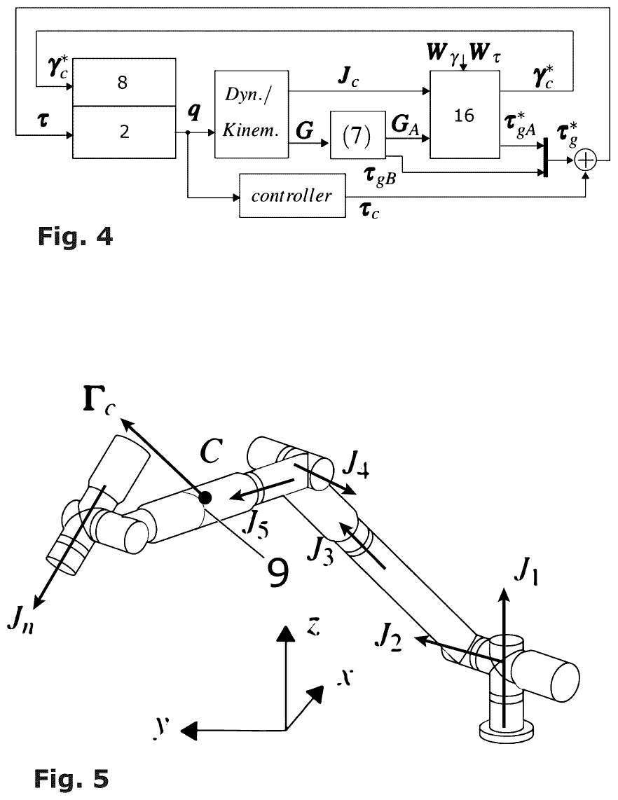

The Jacobian matrix J_{cA} is necessary to transform the forces between the frames. The equation J_{cA}^{T}=J_{A}^{T}B^{T} is also used to define which components are to be taken into account. B contains information on which components the support device can implement. For example, the support device can only apply forces and therefore B=(I, 0), where I is a 3-dimensional identity matrix corresponding to the 3 force components. FIG. 4 describes a process represented by the formulae shown.

γ*_{c} is the second control signal for the support device 8. He robot device 2 uses τ as the input for the torques in the actuators 10. Both cause the robot device 2 to move, which results in the joint positions q of the robot device 2. The information about the hinge positions are transmitted via a signal link to the computer device 16. The computer device 16 calculates the gravitational forces G on the robot device 2. At the box (7), specific gravitational loads are selected.

The first additional control signals τ*_{gA} and the second control signals γ*_{c} are calculated in the computer device 16. The robot device 2 receives a first control signal τ that contains both the additional first control signal τ*_{gA} and the natural first control signal τ_{C}.

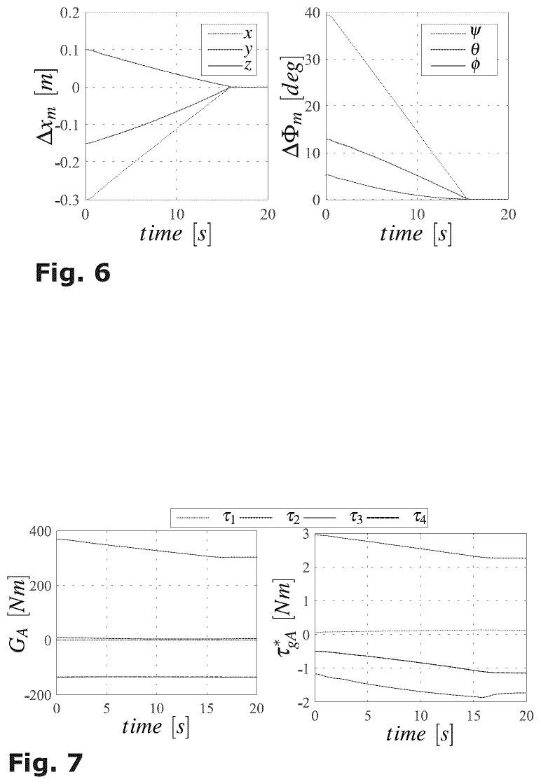

The derivation is explained below. Reference is made to FIG. 5.

The following applies to the dynamics of the robot device 2:

$$H ( q ) \ddot{q} + C ( q , \dot{q} ) \dot{q} + G ( g ) = τ + {J}_{c}^{T} ( q ) {Γ}_{c} \qquad ( 1 )$$

where q∈ [symbol] are the joint angle positions for a robot device with n joints and \dot{q}∈ [symbol] are the joint rates. H(q)∈ [symbol] and C(q, \dot{q})∈ [symbol] are the inertia and Coriolis matrices of the robot device and G(q)∈ [symbol] is the gravitational torque acting on the robot joints. The control torque acting on the joints is τ∈ [symbol] . The external forces and torques (external wrench) Γ_{c}∈ [symbol] on the system at a contact point C, generate a torque on the joints, which is transformed at the contact point using the Jacobian J_{c}(q)∈ [symbol] . The external wrench consists of Γ_{c}=[F_{c}^{T} T_{c}^{T}]^{T}, where F_{c}∈ [symbol] and T_{c}∈ [symbol] are the external force and the external torque, respectively. The control input τ in (1) can be divided into τ_{g} for gravity compensation and τ_{c} for the fulfillment of the desired control tasks, as follows:

$$τ = {τ}_{g} + {τ}_{c} . \qquad ( 2 )$$

Methods for controlling robotic devices traditionally use the technique of gravitational force compensation to compensate for the gravitational force moments acting on the joints, i.e. by actively applying τ_{g}=G.

A suitable control input τ_{c} is then designed in the articulated or Cartesian space to fulfill the control task. However, the configuration-dependent gravitational force torques can exceed the individual joint torque limits. This means that an active gravitational force compensation in these configurations cannot be achieved by the robot device 2 alone. The objective is the distribution of the gravitational load acting on the robot device 2 G between the internal joint torques τ_{g} and the components of the external wrench Γ_{c}, which can be applied by a support device 8. Then the following relationship must be satisfied, which does not interfere with the control task:

$$G = {τ}_{g} + {J}_{c}^{T} {Γ}_{c} . \qquad ( 3 )$$

Γ_{c} are the external forces and torques (external wrench) contact point 9 that a support device must track. Depending on the structure of the external support device 8, it can be possible to apply only certain components of the force and/or the torque at

the contact point. Therefore, γ_{c}∈ [symbol] represents the independent components of the wrench which can be applied on the contact point C or the force application element 9, where
1≤m≤6. Further, B^{T}∈ [symbol] shall be the wrench base which maps γ_{c} on the dimension of the full wrench space. The resulting wrench is.

$${Γ}_{c} in ( 3 ) \qquad ( 4 )$$

$${Γ}_{c} = {B}^{T} {γ}_{c} .$$

For example, if the support device 8 can apply only a force in the z-direction, B=[0 0 1 0 0 0] and γ_{c}∈ [symbol] . Thus, if (4) is inserted into (3), the result is

$$G = {τ}_{g} + {J}_{c}^{T} {B}^{T} {γ}_{c .} \qquad ( 5 )$$

The contact point or the force application element 9 between the robot device 2 and the support device 8 can be located at different positions of the robot device 2 and determines which of the joint moments the external wrench can act upon. Assuming joint numbers 1, 2, . . . , i, where i≤n; and are located between the fixed base and the contact point or the force application element of the robot. This means that the Jacobian transformation at the contact point or the force application element has the following structure,

$${( {J}_{c}^{T} = [ \begin{matrix}{J}_{A}^{T} \\ {0}_{n - i \times 6}\end{matrix} ] )}^{-} \qquad ( 6 )$$

where J_{A}∈ [symbol] is the Jacobian matrix that converts the wrench applied at the contact point into torques at the joints in the set A={x|x∈ [symbol] , x≤1}. The zeros in the bottom lines of the Jacobian show that the applied wrench has no influence on the joints in the set B={x|x∈ [symbol] , i≤x≤n}. This is because the joints in set B are located between the contact point and the free end effector. As a result, (5) can be simplified further with the help of (6) and the terms can be distributed between the joints in sets A and B as follows,

$$G = [ \begin{matrix}{G}_{A} \\ {G}_{B}\end{matrix} ] = [ \begin{matrix}{τ}_{gA} \\ {τ}_{gB}\end{matrix} ] + [ \begin{matrix}{J}_{A}^{T} {B}^{T} {γ}_{c} \\ 0 \text{?}\end{matrix} ] \qquad ( 7 )$$

$$\text{?} \text{indicates text missing or illegible when filed}$$

whereby G_{A} and G_{B} are the gravitational moments of the joints in A and B. Similarly, τ_{gA} and τ_{gB} are the manipulator's gravity compensation moments for the joints in A and B. As can be seen from (7), the external wrench cannot influence the joints in B, which is why these joints are controlled with the gravity moments calculated from the dynamics model as they are, τ_{gB}=G_{B}. From a practical point of view, the position of C should be chosen such that G_{B} does not exceed the torque limits for the operating range of interest. This must be taken into account in the design phase, since the joints that are closer to the robot's free end effector experience fewer gravitational moments anyway.

The remaining joint moments τ_{gA} and the external wrench components γ_{c} can be designed such that the gravity load is distributed between the two variables in compliance with some optimality criteria so that the following relationship from (7) applies,

$${G}_{A} = {τ}_{gA} + {J}_{cA}^{T} {γ}_{c} \qquad ( 8 )$$

where the contact Jacobian matrix isJ_{cA}^{T}=H_{A}^{T}B^{T}. J_{cA}^{T} is generally not square and therefore not invertible. Therefore,γ_{c} cannot be solved directly, for example by setting the torques τ_{gA}=0. An optimum solution is therefore sought for the distribution of the external forces and torques of the joint motors.

In order to optimally distribute the gravity compensation torques between the joint motors and the transmission device, the following optimization problem is formulated with (8) as a constraint,

$${min}_{( {τ}_{gA} , {γ}_{c} )} \frac{1}{2} [ \begin{matrix}{τ}_{gA}^{T} & {γ}_{c}^{T}\end{matrix} ] [ \begin{matrix}{W}_{τ} & 0 \\ 0 & {W}_{γ}\end{matrix} ] [ \begin{matrix}{τ}_{gA} \\ {γ}_{c}\end{matrix} ] \qquad ( 9 )$$

$$s . t . {G}_{A} = {τ}_{gA} + {J}_{cA}^{T} {γ}_{c} \qquad ( 10 )$$

where W_{τ}∈ [symbol] and W_{γ}∈ [symbol] the weighting matrices for the joint moments and the external wrench components. It should be noted that the inputs of the robot device τ_{gA} and the inputs of the transmission device γ_{c} in (9) are not coupled, since the inputs in the present embodiment originate from two separate hardware systems.

To solve the optimization problem, the Lagrange multiplier method is used, in which a series of non-negative multiplicative Lagrange multipliers (λ≥0) extend the target function by the equations of the constraints,

The minimum of the modified function L that satisfies the constraint is

$$L = \frac{1}{2} [ \begin{matrix}{τ}_{gA}^{T} & {γ}_{c}^{T}\end{matrix} ] [ \begin{matrix}{W}_{τ} & 0 \\ 0 & {W}_{γ}\end{matrix} ] [ \begin{matrix}{τ}_{gA} \\ {γ}_{c}\end{matrix} ] + {λ}^{T} ( {G}_{A} - {τ}_{gA} - {J}_{cA}^{T} {γ}_{c} ) . \qquad ( 11 )$$

calculated as

$$∇ L ( x , λ ) = 0 , \qquad ( 12 )$$

$$with$$

$$x = ( {τ}_{gA} , {γ}_{c} )$$

which leads to

$$\frac{\partial L}{\partial {τ}_{gA}} = {W}_{τ} {τ}_{gA} - λ = 0 \qquad ( 13 )$$

$$\frac{\partial L}{\partial {γ}_{c}} = {W}_{γ} {γ}_{c} - {J}_{cA} λ = 0 \qquad ( 14 )$$

$$\frac{\partial L}{\partial λ} = {G}_{A} - {τ}_{gA} - {J}_{cA}^{T} {γ}_{c} = 0 \qquad ( 15 )$$

From (13) and (15) the Lagrange multiplier results as

$$λ = {W}_{τ} ( {G}_{A} - {J}_{cA}^{T} {γ}_{c} ) \qquad ( 16 )$$

If (16) is inserted into (14), the optimum wrench γ*_{c} is obtained.

$${γ}_{c}^{*} = {( {W}_{γ} + {J}_{cA} {W}_{τ} {J}_{cA}^{T} )}^{- 1} {J}_{cA} {W}_{τ} {G}_{A} . \qquad ( 17 )$$

The optimized joint torques, τ*_{gA}, can be obtained by substituting (17) in (10), which leads to the following result,

$${τ}_{gA}^{*} - ( I - {{J}_{cA}^{T} ( {W}_{γ} + {J}_{cA} {W}_{τ} {J}_{cA}^{T} )}^{- 1} {J}_{cA} {W}_{τ} ) {G}_{A} . \qquad ( 18 )$$

The solutions in (17) and (18) distribute the gravitational moments GA optimally to γ_{c} and τ_{gA}. In particular, (17) is the desired force to be tracked by the external carrier, and (18) is the joint torque input to the robot device for the joints in the set A. The existence of the solutions (17)-(18) is summarized in Table I and discussed as follows, where A>0 means that the generic matrix A is positive definite.

TABLE I

| | | Dimensionality | | | Singularity- |
|---|---|---|---|---|---|
| Case | Weight | i > m | i = m | i < m | independent |
| (i) | W_{τ} > 0 [symbol] W_{γ} = 0 | γ*_{c} = (J_{cA}W [symbol] J [symbol] )⁻¹J_{cA}W [symbol] G_{A} | γ [symbol] = J_{cA} [symbol] G_{A} and τ [symbol] = 0 | ill-posed | X |
| | | [symbol] = (1 − J_{cA} [symbol] (J_{cA}W [symbol] J_{cA} [symbol] )⁻¹J_{cA}W [symbol] ) G_{A} | | | |

| | | | |
|---|---|---|---|
| (ii) | W_{τ} = 0 [symbol] W_{γ} > 0 | γ [symbol] = 0 and τ [symbol] = G_{A} | ✓ |
| (iii) | W_{τ} > 0 [symbol] W_{γ} > 0 | γ [symbol] as in (17) and τ [symbol] as in (18) | ✓ |

[symbol]

indicates data missing or illegible when filed

Table 1 shows the optimal solutions of the problem summarized for different cases of weight matrices, dimension and singularity.

Case (i): W_{τ}>0 and W_{τ}=0. The existence of the solution depends on the dimensionality of the external wrench of the robot device and the rank of the Jacobian matrix:
If i>m, the dimension of the joints i that can be compensated by gravity is larger than the dimension of the external wrench components m. The solution exists only in singularity-free robot configurations. In this case, the joint torques resulting from the optimized external wrench components, J_{cA}^{T}γ*_{c}, are projected G_{A} onto the domain space (image) of J_{cA}^{T}, and τ*_{gA} in (18) projected G_{A} onto the null space (kernel) of cA. In other words, the joint moments that cannot be generated by the external wrench are actively compensated for by the robot joint torques.
If i=m, the dimension of the joints i equals the dimension of the external wrench components m. In this case, J_{cA}^{T} is square, and in singularity-free robot configurations γ*_{c} is obtained by the inversion of the transposed Jacobian matrix. In other words: The support device 8 can completely compensate for the gravitational force moments and no joint moments have to be applied.
If i <m, the dimension of the joints i, which can be compensated for by the gravitational force, is smaller than the dimension of the external wrench components m. In this case, the problem becomes unsolvable by the setting W_{γ}=0. This is not a limitation in the physical capability of the support device, but only in the problem definition, since there is no metric for which an optimal solution can be found. The lowest costs in (9) would be achieved for τ*_{gA}=0. Since in this case, the matrix is a J_{cA}^{T}a i×m-matrix with i<m, the problem is still not optimally solved, as can be seen from (10). This means that there are several solutions for γ_{c}, but since W_{γ}=0 none of the solutions can be chosen, the problem is ill-posed. To obtain an optimum solution, when i<m, it is therefore useful, to set W_{γ}to a value not equal to zero.

Case (ii)¹: If W_{τ}=0 and W_{γ}>0, have no limit on the torques of the internal joint motors, then γ*_{c}=0τ*_{GA}=G_{A} and the solution is singularity-independent.

Case (iii): If W_{τ}>0 and W_{γ}>0, there is always an optimal solution. This is independent of the rank of the Jacobian component or the dimensionality of the external wrench components, since the invertibility of the weighted terms in (17) and (18) is determined by the positive definiteness of W_{γ}, Therefore, there is also a solution for singular configurations of the robot.

The suggested strategy is shown schematically in FIG. 4. From the measured joint positions, q, the dynamics and kinematics (Dyn. I Kinem.) of the robot element are calculated. The corresponding Jacobian at the coupling point, J_{c} and the vector G_{A} are the input for the computer device 16, whose outputs are sent to the support device 8 and the robot device 2. The final signal for the robot device is τ*_{g}=[τ*_{gA}; τ_{gB}]. His includes the optimized torque τ*_{gA} and the gravitational force torque for the joints in set B (between the contact point and the free end effector of the robot chain). It can be seen from FIG. 4 that the suggested strategy will not affect the validation of a controller, i.e. the independent torque input τ_{c}.

It should be noted that form a practical point of view, the external carrier could have hardware-related limitations, e.g. with respect to the application of a minimum force γ_{c}. This could be taken into account in the solution, by adding additional inequality conditions for the optimization problem in (9), (10).

Hereinafter, the simulation and test results are shown that were obtained with the method proposed. The robot system considered is the CAESAR arm, a torque-controlled robot with 7 dof and a length of about 2.4 min in an extended configuration. Its weighs about 60 kg and the maximum allowable joint torque is ±80 Nm, see. The weight matrices are defined as W_{τ}=diag(1/τ_{i,max}²) where τ_{i,max} is the maximum torque of the i-th joint, and

$${W}_{γ} = diag ( 1 / {γ}_{i , max}^{2} ) ,$$

$$where$$

$${γ}_{i , max}$$

is the maximum of the the external components of the wrench. In order to show the flexibility of the method, during validation, different force application points C and different support devices are considered in simulation and experiment, which support devices can track different components of the external wrench.

In order to illustrate the flexibility of the method, it is assumed that the contact point C is at J₄, for example, (see FIG. 5), and the support device 8 can track the force in the x-y-z directions, but can track the torque only in the x and y directions. This means that the set A, which lies between the fixed base and the contact point C, is A={1,2,3,4}, B={5,6,7} and the wrench base of the support device will be B=[I_{5×5}0_{5×1}]. The weight τ_{i,max}=80 Nm is selected for W_{τ}, and γ_{i,max}=500 N,Nm is selected for W_{γ}.

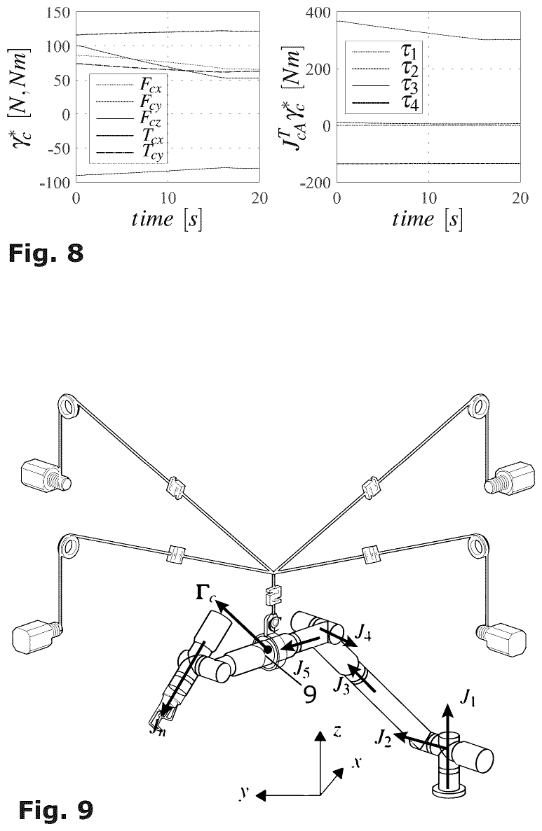

Based on the initial configuration shown in FIG. 5, a relative position in the Cartesian coordinate system of [−0.3 0.1 −0.15] m and a relative orientation of [40 5 12] deg is specified for the tool of the CAESAR arm with the aid of a Cartesian impedance controller. The position and orientation error of the controller during movement is shown in FIG. 6.

The benefits of the suggested method are shown in FIG. 7. If the suggested method is not used, the gravitational torques required by the arm exceed the limit value of ±80 Nm (see FIG. 7 (left) with values up to 370 Nm and −130 Nm).

FIG. 7 (right) shows the gravitational force torque resulting from the suggested method in set A. As can be seen, the maximum torque is now less than 3 Nm. To achieve full gravity compensation, the carrier must follow a required wrench, which is the result of the suggested method (see FIG. 8, left). For validation purposes, FIG. 8 (right) shows the same force, but transformed into the joint space of the robot device. From FIG. 7 and FIG. 8 (right) it is obvious that complete compensation of the gravitational force of G_{A} is achieved and the condition in (10) is satisfied.

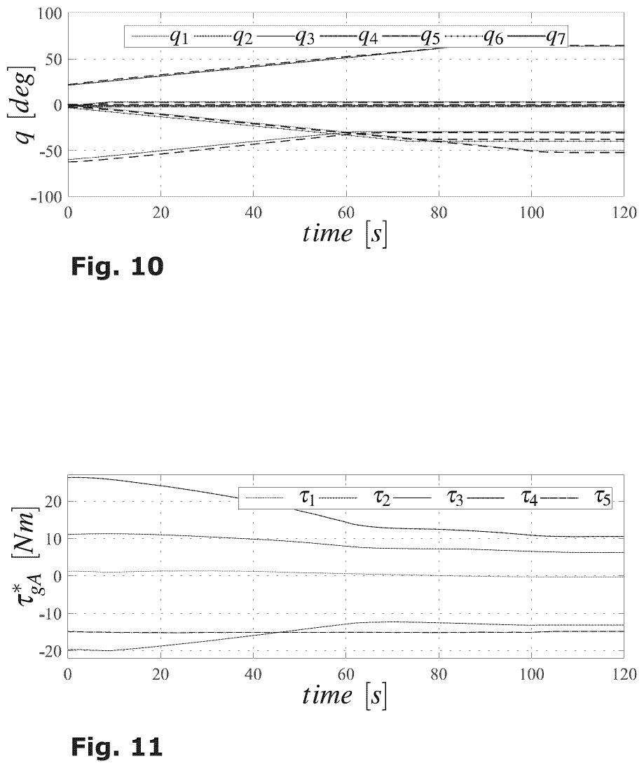

A cable-driven system is used as the support device 8, which is connected to the CAESAR arm via a force transmission element 9 at point C (see FIG. 9). The control of the support device at 4 kHz and is able to follow a desired Cartesian force with the help of an admittance control. The desired force is therefore the input to a dynamic model in which the acceleration is calculated and discretely integrated. In this way, the cable-guided system is given a new set value by the inverse kinematics. The support device 8 shown in FIG. 9 has four motors and can only apply and track translational forces along the components x-y-z, but no torques. This means that the base of the wrench is B=[I_{3×3}0_{3×3}]. Moreover, the position of point C has been chosen according to J₅ such that G_{B} does not exceed the torque limits for the working range to be Js expected. From this, it results for set A A={1,2,3,4,5} and for the set between the contact point and the free end effector B={6,7}. As explained in section III by (7), τ_{gB}=G_{B}, i.e. the force applied to point C, cannot influence the joint in set B. are selected as τ_{i,max}=80 Nm and γ_{i,max}=750 N.

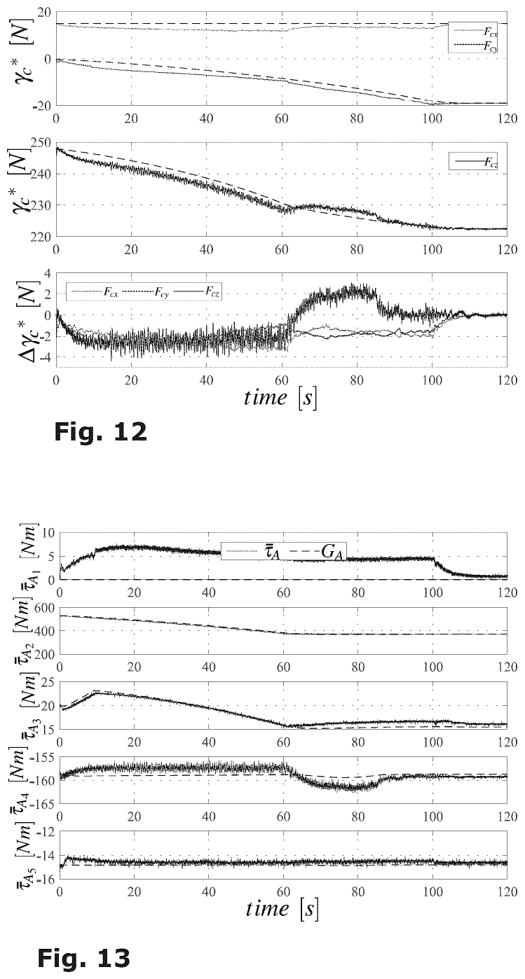

In an experiment, the movement of CAESAR from an initial position to the final position is examined at 1 KHz, with a joint impedance controller being used. The trajectory of the joint position which the robot device was instructed to observe, is illustrated in FIG. 10 and are compared with the measured data. The optimum gravity moments that result from the suggested method are illustrated in FIG. 11 and are instructions to the CAESAR arm. As can be see, these are below the considered torque limit values of 80 Nm. The optimal forces generated for the support device are illustrated in FIG. 12 and are compared with the measured values of the carrier system. The error in force tracking Δγ*_{c} is below 4 N and, in a static position, approximates zero (see after 100 s). For validation, the required gravity moment during movement, G_{A}, is compared with the overall forces (internal joint moments and external forces of the carrier) acting on the robot device. This is calculated from the measurement as follows,

$$\overline{τ} = {τ}_{msr , A} \text{?} - {τ}_{c , A} + {J}_{CA}^{T} {γ}_{{c}_{msr}}^{*} \text{?}$$

$$\text{?} \text{indicates text missing or illegible when filed}$$

where (msr,A) indicates the corresponding measured value in the set A. The comparison is shown in FIG. 13, with the largest error showing at joint 1 caused by the admittance-controlled support device during tracking. In a static position, however, the error is close to zero (see after 100 s). This experiment shows that the suggested strategy is suitable for testing the robotic system on the ground.

According to the disclosure, a strategy for compensating the gravitational force of a robot device for tests under the influence of gravitational force is suggested. The approach solves an optimal problem that minimizes the torque of the joints and as a result provides a desired force that can be tracked by a support device. Experimental results with the CAESAR arm show the effectiveness of the method using a cable-suspended system as a support device to achieve the desired compensation force.

What is claimed is:

1. A method for controlling a robot device, the robot device comprising at least one robot element pivotable about at least one first robot joint, the method comprising the steps of:
moving the at least one robot element by at least one actuator,
controlling the actuator by a first actuator control device that sends first control signals to the actuator,
supporting the robot device by a support device,
wherein the support device has second gravity-compensating control signals sent thereto by a support control device, and
wherein the support device is controlled thereby so that at least one force and/or one moment is applied to the robot element via a force-applying element that is connected to the robot element at at least one point, which force and/or moment at least partially compensates for the acting gravitational load acting on the robot element,
wherein, in order to compensate for a gravitational force acting on the robot element, not only gravity-compensating second control signals are sent from the support control device to the support device, but also additional first gravity-compensating control signals are sent from the actuator control device to the actuator.

2. The method according to claim 1, wherein the gravitational load acting on the robot device is calculated by a computer device and, depending thereon, the gravity-compensating first and second control signals are calculated by the computer device and sent to the actuator control device and the support control device.

3. The method according to claim 1, wherein the compensation of the gravitational load is calculated by a computer device that is divided into the gravity-compensating first control signals and the gravity-compensating second control signals, the distribution between the first and second control signals being determined by the computer device.

4. The method according to claim 3, wherein the optimum distribution of the gravity-compensating first control signals and gravity-compensating second control signals is calculated by a computer device.

5. The method according to claim 4, wherein the distribution of the gravity-compensating first control signals and the gravity-compensating second control signals is optimized by a computer device such that the required torque or torques in the at least one robot joint are reduced.

6. The method according to claim 1, wherein the at least one actuator is a motor, either on or in the at least one robot joint.

7. The method according to claim 1, wherein the gravity-compensating second control signals are calculated by a computer device as follows:
$${γ}_{c}^{*} = {( {W}_{γ} + {J}_{cA} {W}_{τ} {J}_{cA}^{T} )}^{- 1} {J}_{cA} {W}_{τ} {G}_{A} . \text{?}$$
$$\text{?} \text{indicates text missing or illegible when filed}$$

8. The method according to claim 1, wherein the additional gravity-compensating first control signals are calculated by a computer device according to:
$${τ}_{gA} \text{?} = ( I - {{J}_{cA}^{T} ( {W}_{γ} + {J}_{cA} {W}_{τ} {J}_{cA}^{T} )}^{- 1} {J}_{cA} {W}_{τ} ) {G}_{A} .$$
$$\text{?} \text{indicates text missing or illegible when filed}$$

9. The method according to claim 1, wherein the actuator control device and the support control device are a common control device.

10. The method according to claim 1, wherein the support device is a parallel robot system or a serial kinematic system that comprises at least one actuator that can move the elements of the support device so that the direction and magnitude of the force that can be exerted on the robot element are adjustable.

11. The method according to claim 10, wherein the support device is a cable robot system comprising at least two cable elements, each cable element being connected to at least one motor that moves the respective cable element so that the direction and amount of force that can be applied to the robot element is adjusted.

12. A robot system, comprising
a robot device, the robot device comprising at least one robot element pivotable about at least one first robot joint, with
at least one actuator for moving the at least one robot element,
at least one actuator control device for controlling the actuator, the actuator control device being configured to send a first control signal to the actuator,
at least one support device for supporting the robot device, a support control device being provided that is configured to send second gravity-compensating control signals to the support device and to control the support device so that at least one force and/or one moment can be applied to the robot element via a force-applying element that is connected to the robot element at at least one point, which force and/or moment at least partially compensates for the acting gravitational load acting on the robot element,
wherein, in order to compensate for a gravitational force acting on the robot element, the support control device and the actuator control device are configured to not only send gravity-compensating second control signals from the support control device to the support device, but to also send additional first gravity-compensating control signals from the actuator control device to the actuator.

13. The robot system according to claim 12, further comprising a computer device configured to calculate the gravitational load acting on the robot device and, depending on this, to calculate the gravity-compensating first and second control signals and send them to the actuator control device and the support control device.

14. The robot system according to claim 12, wherein the at least one actuator is a motor on or in the at least one robot joint.

15. The robot system according to claim 13, wherein the computer device is configured to divide the compensation of the gravitational load into the gravity-compensating first control signals and the gravity-compensating second control signals, and wherein the distribution between the first and second control signals can be determined as desired by the computer device.

16. The robot system according to claim 15, wherein the computer device is configured to calculate the optimum distribution of the gravity-compensating first control signals and gravity-compensating second control signals.

17. The robot system according to claim 15, wherein the computer device is configured to optimize the distribution of the gravity-compensating first control signals and the gravity-compensating second control signals such that the required torque or torques in the at least one robot joint are reduced.
